(19) United States
(12) Patent Application Publication
(10) Pub. No.: US 2023/0037507 A1
(43) Pub. Date: Feb. 9, 2023

(54) Method for Producing a Multilayered Coated Food Product

(71) Applicant: Heat and Control, Inc., Hayward, CA (US)

(72) Inventors: Emmanuel Becerra Andrade, Tonala (MX); Andrew Anthony Caridis, San Carlos, CA (US)

(73) Assignee: Heat and Control, Inc., Hayward, CA (US)

(21) Appl. No.: 17/972,374

(22) Filed: Oct. 24, 2022

Related U.S. Application Data
(63) Continuation-in-part of application No. PCT/IB2021/053310, filed on Apr. 21, 2021.

(30) Foreign Application Priority Data
Apr. 23, 2020 (MX) MX/A/2020/004236

(51) Int. Cl. A23L 25/00; A23L 5/10; A23P 20/10

(52) U.S. Cl. CPC A23L 25/25; A23L 5/11; A23L 5/15; A23P 20/10; A23V 2002/00

(57) ABSTRACT

A method of producing a multicoated edible snack product comprising providing an edible core, applying a first layer over the outer surface of the edible core. The first layer is cooked to form a hardened first layer over the edible core. A second layer is applied over the hardened first layer, and cooked to form an expanded second layer. The hardened first layer provides a crunchy aspect to the snack product and the expanded second layer provides a soft exterior to the snack product when biting into the snack product.

### CROSS REFERENCE TO RELATED APPLICATION

This application claims priority to International Application Number PCT/1B2021/053310 filed Apr. 21, 2021, which claims priority to Mexican patent application number MX/a/2020/004236 filed Apr. 23, 2020, the entire content of each of which is incorporated herein by this reference.

### FIELD OF THE INVENTION

Present invention lies within the field of product coatings. Specifically, it refers to a method for coating food products with a spherical or semi-spherical, oval, ovoid, elliptical shape etc. Preferably, the method is applied to nuts, peanuts, seeds, etc. The method allows obtaining products with improved physical and sensory features obtained by an efficient, simple and economic process.

### BACKGROUND

The process of coating food products with formulations based on solid mixtures (powders) composed by starches, flours, among others, and liquid mixtures such as syrups, honey, among others, is widely known in the state of the art, such is the case for peanuts, nuts and other types of seeds. Similarly, within the coating methods or processes, the use of thermal procedures such as baking, frying or toasting following the application of the coating are well known, with the end goal of drying it or dehydrating it (also known as the “curing” step) to ensure that said coating acquires the desired texture, which is normally crunchy.

Typically, those products which are produced by the application of a single coating followed by a frying step are known as “Dutch” peanuts. On the other hand, “Japanese” peanuts are a type of peanut which, unlike the Dutch counterpart, is baked in order to cure the coating.

Processes also exist in the state of the art for preparing food products coated with more than one layer of coating.

WO2013009176, for example, describes a process for preparing a coated dried fruit, which consists of applying at least one coat to the product and later curing it by means of thermal treatment, which is preferably undertaken by toasting, baking or frying. In the preferred embodiment, the coated product is baked at 160° C. for 25 minutes to be cooled later at a temperature lower than 50° C. and later be toasted at 170° C. for 20 minutes. It should be highlighted that this document discloses curing as a final step. Even though the product may be coated several times, only one curing is undertaken, whether it is with one or several thermal treatments. A curing step is not undertaken between coatings.

CN104013037, for example, details a production process for fried peanuts toasted with honey comprising the following steps: pre-processing the peanuts (A-B); coating the peanuts with a first formulation which includes starch (C); frying (E) in a system which has three temperature zones (105-110° C.; 150-165° C. and 180-190° C. with times of 8-12 minutes, 5-8 minutes and 2-5 minutes, respectively) which are controlled by PLC; cooling of the peanuts (F); application of a second coating comprising a solution which includes honey (H) and baking at 130° C. (I). This document discloses first frying and later the baking of the peanuts.

Notwithstanding the above efforts, the need exists for providing coated food products with improved physical and sensory features by means of processes which are efficient, simple and cost efficient.

### BRIEF DESCRIPTION OF THE FIGURES

The following figures illustrate one or more embodiments of the invention and are not be considered as limiting of the invention.

FIG. 1a is a perspective view of a whole peanut.

FIG. 1b is a cross section of a peanut.

FIG. 1c is an upper view of one half of a peanut.

FIG. 2 is a cross section view of a multicoated edible core of the invention.

FIG. 3 is a flow diagram of the method of the present invention.

### DETAILED DESCRIPTION OF THE INVENTION

The instant invention discloses a method of producing a multilayered coated edible snack product that can include the steps of: a) providing an edible raw core with an outer surface; b) applying at least a first cookable or coating layer over the outer surface of the raw core; c) cooking the raw core covered with the at least a first cookable or coating layer in order to form a first cooked layer; d) applying at least a second cookable or coating layer over the first cooked layer; e) cooking the at least second cookable or coating layer in order to form a second cooked layer. The layering process can be repeated as many times as needed, for example to control the thickness of the multilayered shell surrounding the edible core. After processing, the raw edible cores are converted to cooked edible cores of a multilayered coated edible snack product. The second cooked layer can optionally have a thickness that is different, for example greater, than the thickness of the first cooked layer. The first cooked layer can optionally be hardened. The second layer can optionally expand during cooking.

The multilayered coated edible snack product obtained through the method of instant application can be crunchy on the outside and soft within, such that it presents a pleasant consistency upon biting into it. The second cookable or coating layer can expand the resulting snack product by greater than 35%, for example in the range of approximately 35% to approximately 50%, and can result in a high porosity between both coating layers, for example in the range of approximately 60% to approximately 90%. In this manner, the first layer coating can be separated from the second layer coating, which contributes to a greater volume of the product and gives the sensation of a larger amount of product with few supplies, thereby reducing the cost of the product.

The method of present invention may be applied to any product, including products with a spherical or semi-spherical, oval, ovoid or elliptical shape. The product can be of any suitable type, including for example any suitable food product. Sample food products include nuts, almonds, peanuts, nut derivatives, seeds, legumes, garbanzo beans, lima beans, whole grains, corn, seeds, fruits, dried fruits, fruits derivatives, dried vegetables, or any combination or mixture of the foregoing.

Other aspects, embodiments, and advantages of those exemplary aspects and embodiments are discussed in detail below. The description provides illustrative examples of various aspects and embodiments of the present invention, and is intended to provide an overview or framework for understanding the nature and character of the aspects and embodiments claimed. The accompanying figures are included to provide additional illustration and understanding of the various aspects and embodiments, and are incorporated into and constitute a part of this specification. The figures, together with the specification, can serve to explain the aspects and modalities described and claimed.

The following description is exemplary only and is not intended to limit the disclosed embodiments or the application and uses of the disclosed embodiments. As used herein, the word “exemplary” or “illustrative” means “serving as an example, instance, or illustration.” Any implementation described herein as “exemplary” or “illustrative” should not necessarily be construed as preferred or advantageous over other implementations. All of the implementations described below are exemplary implementations provided to enable those skilled in the art to make or use the embodiments of the disclosure and are not intended to limit the scope of the disclosure. For purposes of the present description, the terms “top”, “bottom”, “left”, “rear”, “right”, “front”, “vertical”, “horizontal” and their derivatives will refer to the invention as orient in Figures. Furthermore, there is no intention to be bound by any explicit or implicit theory presented in the above technical field, background, brief summary, or the following detailed description. It should also be understood that the specific devices and processes illustrated in the accompanying drawings, and described in the following specification, are merely exemplary embodiments of the inventive concepts defined in the appended claims. Therefore, specific dimensions and other physical characteristics related to the embodiments described herein are not to be construed as limiting, unless the claims expressly state otherwise.

For purposes of present invention, the use of the term “approximately” provides an additional determined range. The term is defined in the following manner. The additional range provided by the term is +10%. By way of example, but not in a limiting manner, should it read “approximately 40 g”, the exact range is between 36 to 44 g.

In the same manner, the compositions or concentrations indicated in terms of a percentage are referred to in weight, unless is indicated otherwise.

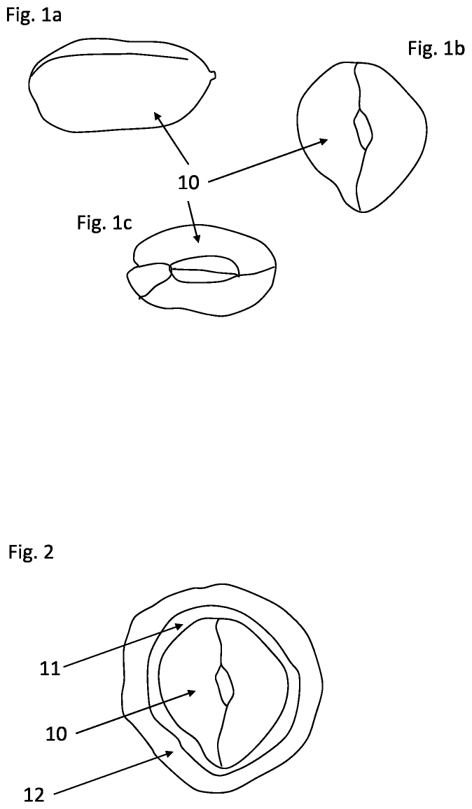

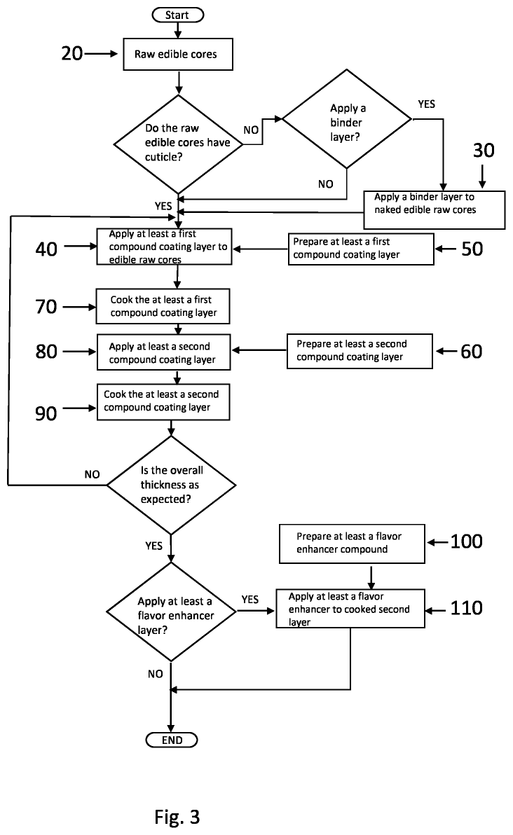

In FIG. 3 an optional flow diagram of the method for producing a multilayered coated product, for example an edible snack product, of the present invention. The process begins with block 20 that requires the addition and preparation of the raw edible cores 10. Examples of raw edible cores 10 are shown in FIGS. 1a, 1b, 1c, where a peanut is illustrated as an example of an edible core 10. The edible raw cores 10 can be supplied into the process of the invention complete or in halves (see FIG. 1c). Depending on the type of the edible raw core 10, it can include or not include a cuticula cover. The edible raw core 10 can be of any suitable type, for example nuts, almonds, peanuts, nut derivatives, seeds, legumes, garbanzo beans, lima beans, whole grains, corn, seeds, fruits, dried fruits, fruits derivatives, dried vegetables or any combination or mixture of the foregoing. The edible core 10 can be provided raw, which is an advantage on the process of the invention since the edible raw core 10 gets cooked during the layering process.

Prior to beginning the method proposed herein, an edible raw core product 10 is provided and serve as the base for producing a multilayered coated product, for example snack product, of the invention.

The amount or number of edible raw or other cores 10 to be supplied, which can be in a continuous fashion or in batch, can depend on the capacity of the equipment to be used for the coating or layering process of the invention, the desired amount of multilayered product to be produced or both. The steps of the procedure can be the same, that is in a continuous fashion or in a batch, including independent of or dependent upon the foregoing parameters. For simplicity, the cores shall be referred to as edible cores or edible raw cores herein, it being understood that the cores to be processed can be of any suitable edible or other type.

Once a batch of edible raw cores 10 are ready for processing, where a batch of edible raw cores can range from 100 gr to 250 kg depending on the capacity of the equipment to be used, the user determines if the edible raw cores 10 possess a cuticula cover or skin. If there is no cuticula present on the core, the process can optionally include the step of applying a binder layer on the naked edible raw cores 10, for example as shown in block 30 in FIG. 3. This binder layer can be of any dough recipe known in the art, for example one having a liquid base such as syrup and a dry component of a flour of any suitable type. Such flour can include, for example, corn flour, wheat flour, rice flour or any combination of the foregoing. The binder layer can be of any suitable thickness, for example ranging from 0.01 mm to 0.05 mm. The binder layer can inhibit the edible raw cores from sticking to one another. The binder layer can allow or enhance the at least a first coating layer 11 adhering to the core. The application of the binder layer to one or more cores can be accomplished in any suitable manner or method available in the art, for example on a panning device, conveyor tumbling drum or centrifuge tub. The edible raw cores 10 coated with a binder layer, where desirable, can move to the block 40 step.

When the edible raw core 10 is supplied without a cuticle, an edible binder coating can optionally be added to enhance the first coating layer 11 being fixed to the resulting food product. Examples of suitable binders include gums or gelatin; however, a variety of compounds can be used.

Where the edible raw cores 10 have no cuticula, but no binder layer is to be applied to the cores for example in block 30 step of FIG. 3, the naked edible raw cores 10 can bypass block 30 step and move to the block 40 step.

### First Coating Layer 11

The raw edible cores, for example cores 10, can optionally be coated with at least one first coating layer.

In any case with or without cuticula or with or without block 30 binder layer, the edible raw cores 10 can be coated with at least one first coating layer 11, which can optionally be referred to as a coating layer, a heatable layer, a compound layer, a mixture layer, a cookable layer or any combination of the foregoing. The cookable or heatable components of layer 11 can be of any suitable type, and prepared for example in step 50 of the method of FIG. 3. Layer 11 can optionally include a dry component and a liquid, for example a liquid base. Such dry component can be of any suitable type, for example flour, and can optionally include other recipe specific ingredients selected as a function of the type of the final product. The flour can be of any suitable type, for example corn flour, wheat flour, rice flour or any combination of the foregoing. Such recipe specific ingredients can include any kind of flour such as corn flour, wheat flour, rice flour, salt, flavoring or any combination of the foregoing. The liquid can be of any suitable type, for example syrup, and can optionally include other recipe specific ingredients selected as a function of the type of the final product. The liquid can optionally be in form of a syrup to which starch, water or any combination of the foregoing is optionally added. Such recipe specific ingredients can include, without limitation for example, sugar, soy, an edible oil, seasoning, protein, an emulsion stabilizer or any combination of the foregoing. Layer 11 can optionally include the dry component of wheat flour and syrup as the liquid base, and other optional components disclosed herein. Layer 11 can optionally include a dry component and a mixture of liquid and starch of any suitable proportion. The layer 11 can optionally have a first content of starch, for example approximately 10% to 30% in weight, and a first content of flour or other dry component, for example approximately 40% to 70% in weight, and a liquid base of any suitable type, for example syrup. The ingredients of the first layer 11 can optionally be referred to as the cookable components or ingredients of the layer 11.

The equipment suitable for performing the coating operation can be of any suitable type, includes without limitation for example a panning device, conveyor, tumbling drum or centrifuge tub, mixing vessels, coating tubes, fluidized bed driers, other coating methods available in the art or any combination of the foregoing. When the equipment is a centrifuge tub, the liquid base and dry component prepared on block 50 can be added to the center of the tub and due to centrifugal force, the liquid base and dry component reach the edible raw cores 10 that are radially accommodated on the circumferential wall of the tub due to the centrifugal force. The centrifuge tub can rotate at any suitable speed, for example from 100 rpm to 3000 rpm. The centrifuge residence time of the tub can be of any suitable duration, for example from one minute to 30 minutes. The speed and centrifuge residence time of the equipment, the net product process volume per hour, the specific recipe of the liquid base and dry component, for example prepared in block step 50, and other engineering and process related variables will depend on the size of the batch of edible raw cores 10 to be treated treat.

The application of the at least a layer of the compound and recipe specific ingredients, for example the first coating layer 11, can optionally be undertaken in an automatic dosing coating equipment, which for example can be any commercially known apparatus, by dripping, centrifuge, aspersion, immersion or any combination of the foregoing. A centrifuge coating apparatus can optionally be used. The equipment can optionally be programmed so that it can dose the powder and liquid ingredients, for example little by little, into the automatic dosing coating equipment or recipient containing the edible raw cores 10. The dosing can optionally occur at the same time that the recipient is rotated at a high speed. The automatic dosing equipment containing the edible raw cores 10 can uniformly distribute the at least a first coating layer with the recipe specific ingredients on to the cores.

The dosing or addition of the at least a first coating layer, for example in block step 50, which forms the first coating layer 11 can optionally be undertaken manually, for example in any suitable layer application equipment such as a centrifugal drum or tub. The edible raw cores 10 can be introduced into the suitable layer application equipment either manually or with the aid of transferring equipment, for example conveyor belts. The operator can optionally manually add the first compound of block 50, for example after previously weighing the ingredients thereof. The edible raw cores 10 can optionally be allowed to rest between the addition of each batch of compound and recipe specific ingredients of block 50, with the end goal of achieving a uniform coating. Said rest time can depend on the recipe specific ingredients along with the experience of the operator.

At the end of this step, for example block step 40, edible raw cores 10 coated with at least a first coating layer 11 are obtained.

Once the batch of edible raw cores 10 is coated with the at least a first coating layer and dried, the coated cores can be removed from the coating equipment and transferred to a heating equipment in order to perform a first heating or cooking process of any suitable type, for example baking. Suitable heating equipment can include, without limitation for example, a gas or electric convection oven, a muffler, a conveyor oven, a fry pan, other means of air or fluid gas heating or any combination of the foregoing. The batch of coated edible raw cores 10 and first coating layer 11 can be heated or cooked in any suitable manner, for example approximately from 150° C. to 200° C. with a heating exposure time of five to twelve minutes. The heating or cooking can optionally be performed at a temperature ranging from approximately 120 ° C. to approximately 200 ° C. The heating or cooking can optionally be performed at a temperature ranging from approximately 140 ° C. to approximately 180 ° C. The exposure time to heating or cooking can optionally range from approximately five minutes to approximately 60 minutes. The exposure time to heating or cooking can optionally range from approximately eight minutes to approximately 40 minutes. The temperature and heating exposure time, the amount of edible raw cores 10 present in the batch, the type of heating equipment, the type of final product specifications, and other engineering and process variables can be a function of the specific recipe of the liquid base and dry component prepared in the first coating step, for example in block step 50. Upon completion of the first cooking process, for example block step 70, the first coating layer 11 of the heated batch of edible cores 10 is cooked, for example baked, and dried and has a first thickness. The first heating or cooking process, for example the temperature and heating exposure time, of the first coating layer 11 optionally do not cook the edible raw cores 10, which in this case result in the cores retaining their raw properties. The heating can optionally be performed by baking. The first heating or cooking process optionally hardens the first layer, and the cooked first layer 11 can optionally be referred to as a hardened first layer. The hardness of the first layer can optionally provide uniformity to the finished products. The cooked second layer can optionally serve to seal the edible core 10.

Any water vapor generated by the evaporation of the water contained in the liquid ingredients during the coating of cores 10 with the first coating 11, for example in block step 40, helps to pre-cook the food product before the first heating or cooking process by taking advantage of the latent heat.

The edible raw cores 10 may optionally be conditioned prior to the heating of the at least a first coating layer 11 in the first heating or cooking processing step. The conditioning can be accomplished in any suitable manner, for example in a conditioning drum, a conveyor belt oven, a conventional batch oven, other known heating or baking equipment or any combination of the foregoing. Depending on the equipment used, the residence time can vary, for example from approximately one minute to one hour. The residence time can optionally vary from approximately one minute to 40 minutes. The residence time can optionally vary from approximately five minutes to 40 minutes. The conditioning step can serve to homogenize the amount of product fed to the heating or baking equipment of the first heating or cooking process and avoid temperature variations within the product.

The first heating process can optionally serve to dry both the first coating layer 11 and the edible raw cores 10 without transforming the food product. In addition, the first heating or cooking process can optionally serve to arrive at a point or cooking, for example baking, condition where a chemical transformation of the components of the at least a first coating layer 11 is achieved. Such chemical transformation can result in particular edible sensory properties, such as the texture, the flavor and the color on the coated product, and mechanical properties, such as resistance to fracture. The foregoing can enhance good handling in the later steps of the process. In the same manner, the first heating or cooking process of the first coating layer 11, for example in block step 70, can provide crispy, crunchy or both properties of the multilayered coated edible snack product of the invention.

At the end of the first heating or cooking process step, for example block step 70, an edible raw core 10 with an overlying first cooked layer 11 can be obtained.

The sequence of steps involving first coating layer 11 and the first heating or cooking process, for example block step 70, can be repeated any number of times, for example as a function of the desired thickness and edible characteristics desired in the resulting multilayered coated edible snack product of the invention.

### Second Compound Layer Coating 12

After the first cooking or heating processing step, for example baking, of the first coating layer 11, at least one second coating layer can be added over the first cooked layer 11 of the product in order to form a second coating layer 12 (see FIG. 2). The addition of the at least one second coating layer, for example of block step 60, can be undertaken immediately, for example right after, the first cooking process, for example of block 70 step, while the product is still hot.

Once the batch of baked edible raw cores 10 layered with the at least a first coating layer is out of the cooking, for example baking, equipment, it can be transferred to a second layering operation, for example in block step 80, where first coated product is coated with at least a second coating layer 12. The second coating layer can optionally be referred to as a coating layer, a cookable layer, a heatable layer, a compound layer, a mixture layer or any combination of the foregoing. The cookable or heatable components of layer 12 can be of any suitable type, and prepared for example in block step 60 of the method of FIG. 3. Layer 12 can optionally include a dry component and a liquid, for example a liquid base. Such dry component can be of any suitable type, or example flour, and can optionally include other recipe specific ingredients selected as a function of the type of the final product. The flour can be of any suitable type, such as corn flour, wheat flour, rice flour or any combination of the foregoing.

Such recipe specific ingredients can include any kind of flour such as corn flour, wheat flour, rice flour, salt, dry spices, chili powder, citric powder, flavoring, low humidity and fine particle size flour or any combination of the foregoing. The liquid can be of any suitable type, for example syrup, and can optionally include other recipe specific ingredients selected as a function of the type of the final product. The liquid can optionally be in form of a syrup to which starch, water or any combination of the foregoing is optionally added. Such recipe specific ingredients can include, without limitation for example, sugar, sucrose or other soy, an edible or other oil, seasoning, protein, an emulsion stabilizer or any combination of the foregoing. Layer 12 can optionally include the dry component of wheat flour and syrup as the liquid base, and other optional components disclosed herein. Layer 12 can optionally include a dry component and a mixture of liquid and starch of any suitable proportion. The layer 12 can optionally have a second starch content, for example approximately 30% to 60% in weight, and a second content of flour or other dry component, for example approximately 10% to 40% in weight, and a liquid base of any suitable type, for example syrup. Second layer 12 optionally has a higher content of starch, a lower content of flour or both relative to first layer 11. The dry component of the second coating layer 12, for example of block step 60, can optionally be wheat flour with a fine particle size, for example ranging from 90 μm to 180 μm. Such flour can inhibit sticking of the at least a second coating layer 12 during the second heating or cooking process step, for example of block step 90. The ingredients of the second layer 12 can optionally be referred to as the cookable components or ingredients of the layer 12.

The at least second coating layer 12 operation can be performed on equipment of any suitable type for performing a coating operation, including without limitation for example, a panning device, conveyor, tumbling drum or centrifuge tub, mixing vessels, coating tubes, fluidized bed driers, other coating methods available in the art or any combination of the foregoing. When the equipment is a centrifuge tub, the liquid base and dry component prepared on block step 60 can be added to the center of the tub and due to centrifugal force, the liquid base and dry component reach the first compound coated raw edible cores 10 that are radially accommodated on the circumferential wall of the tub due to the centrifugal force. The centrifuge tub can rotate at any suitable speed, for example from 100 rpm to 3000 rpm. The centrifuge residence time of the tub can be of any suitable duration. The speed and centrifuge residence time of the equipment, the net product process volume per hour, the specific recipe of the liquid base and dry component, for example prepared in block step 60, and other engineering and process related variables can depend on the size of the batch of first compound coated raw edible cores 10 to be treated.

Commercially available automatic dosing coating equipment can optionally be used for the application of the at least a second coating layer 12, for example by dripping, centrifuge, aspersion, immersion or any combination of the foregoing. Centrifuge equipment can optionally be used. The equipment can optionally be programmed so that it can dose the dry and liquid ingredients little by little into the automatic dosing coating equipment or recipient containing the first coated edible cores 10, that is the edible cores 10 coated with the first compound layer coating 11 and heated or cooked in the first heating or cooking step.

The dosing or addition of the second compound layer 12, for example from block step 60, can optionally be undertaken manually in a suitable layer application equipment, for example in a centrifugal drum or tub. The first coated edible cores 10 can optionally be introduced into the suitable layer application equipment, whether manually or with the aid of any suitable transferring equipment such as, for example, conveyor belts. The suitable layer application equipment can be activated, and the operator can manually add the ingredients of the second compound layer 12, for example of block step 60, for example after previously weighing them. The first edible cores 10 can optionally be allowed to rest or dwell after the addition of the batch of the second compound layer 12, for example of block step 60, for enhancing a uniform coating. The rest or dwell time can depend on or be a function of the experience of the operator, the recipe specific ingredients of layer 12 or both.

The liquid ingredients of the second coating layer 12 may be added at room temperature or may be heated depending on whichever is necessary, for example to facilitate application of the second coating to the first coated cores 10.

Once the at least second coating layer 12 over the batch of edible raw cores 10, previously coated with the at least first coating layer 11, is applied and dried, the product can be removed from the coating equipment and transferred to cooking, for example frying, equipment in order to perform a second heating or cooking process of any suitable type, for example frying. The second heating for cooking process can be of any suitable type, for example of block step 90. Suitable heating or cooking equipment, for example for the operation of block step 90, can include, without limitation for example, a batch fryer, a conveyor fryer, a tub and agitator fryer, other types of deep frying or edible oil fryers, other cooking or frying methods known in the art or any combination of the foregoing. A batch of second compound layered 12 over the first cooked layer 11 edible raw cores 10 can optionally be submerged in an edible frying or cooking fluid that can include, without limitation for example, canola oil, corn oil, palmolein oil, safflower oil, sunflower oil, coconut oil, sesame oil, animal oils, lard, butter, other frying fluids or any combination of the foregoing. The frying fluid or other heating temperature can be any suitable temperature, for example varying from approximately from 150° C. to 200° C. The frying or other heating exposure time can be of any suitable duration, for example approximately eight minutes to 20 minutes. The frying or other heating can optionally be performed at a temperature ranging from approximately 130° C. to approximately 210° C. The frying or other heating can optionally be performed at a temperature ranging from approximately 155° C. to approximately 200° C. The frying or other heating can optionally have an exposure time ranging from approximately one minute to approximately 20 minutes. The frying or other heating can optionally have an exposure time ranging from approximately 2.5 minutes to approximately 18 minutes. The temperature and exposure time can depend on or be a function of the specific recipe of the liquid base and dry component of the second compound layer 12, for example prepared in block step 60, the amount of second coating layer 12 applied over a first cooked compound layered 11 edible raw cores 10 in the batch, the type of frying equipment, the product specifications of the final multilayered coated edible snack product, other engineering and process variables or any combination of the foregoing. Upon completion of the second heating or cooking process, for example in block step 90, with respect to the batch of at least a second coating layered 12 over the first baked coating layered 11 edible raw cores 10, the at least a second coating layer 12 is cooked, for example fried, and dried. The second heating or cooking process can cause the second layer 12 to expand, and can optionally cause at least portions of the second layer to separate from the underlying cooked first layer. The cooked second layer can optionally be referred to as an expanded second layer. The cooked second coating layer 12 can have any suitable thickness, for example ranging from about 0.30 millimeters up to one millimeter. The thickness of the second coating layer 12 can optionally be thicker than the thickness of the first coating layer 11. The temperature, cooking or heating exposure time, the second starch and the second flour content of the second coating layer 12, for example from block step 60, can optionally result in the second coating layer 12 containing the vapor generated during the second cooking operation, for example of block step 90, so as to cause the cooking of the edible raw cores 10. Such cooked cores 10 have lost their humidity and acquired cooked edible goods properties.

A considerable humidity gradient may exist between the first heating or cooking step, for example of block step 70, that cooks the at least a first coating layer 11 and the at least a second coating layer 12 applied to the first coated cores 10, which may inhibit both coatings 11, 12 not adhering to each other and facilitating expansion of the second compound layer coating 12 during the second heating or cooking process, for example of block step 90.

Any edible cooking or frying fluid, for example cooking oil, utilized in the second cooking or heating process can optionally enter the product, and in addition to the previously discussed humidity, facilitate expansion of the second coating layer 12. Such cooking fluid can optionally cause bubbles, for example air bubbles, to form between the second layer and cooked first layer, so as to create a pleasurable sensation when biting into the final product. Bubbles in the cooked second layer can contribute to, for cause, porosity in the cooked second layer. Such bubbles can optionally fill up the space between the first cooked layer 11 and second cooked layer 12.

The second heating or cooking step, for example of block step 90, can additionally allow the edible core 10 with at least a second coating layer 12 over the first cooked layer 11, the first layer having started cooking at the first heating or cooking step, for example of block step 70, to be able to finish cooking.

At the end of the foregoing steps, an edible core 10 with a first cooked layer 11 under a second coating layer 12 is obtained. In this regard, once the edible cores 10 have finished the second heating or cooking step, for example of block step 90, the cores are cooked and allowed to cool, resulting in an edible core 10 product with a multilayered shell. The second heating or cooking step, for example of block step 90, can optionally impart a soft texture to the final product.

In an optional step, the outer shell that is comprised by the multiple layers 11, 12 placed upon the edible cores 10 is checked to determine that it has reached the desired thickness, for example as shown in FIG. 3. The aggregate thickness of the outer shell can depend on or be a function of the type of desired end product. Depending on the foregoing and the specific recipe followed, the user or operator can determine the overall thickness of the outer shell. If the desired aggregate thickness of the outer shell has been achieved, then the process of layering coatings over the cores is complete. If the desired aggregate outer shell thickness has not been achieved, then some or all of the process of layering additional coatings, for example in block steps blocks 40 to 90, can be repeated. In this regard, one or more additional first layers 11 can be provided in sequence, one or more additional second layers 12 can be provided in sequence or one or more first layers 11 and overlying second layers 12 can be provided in sequence. The number of first layers 11 applied to the edible core 10 can optionally range from between one to 100. The number of first layers applied to the edible core 10 can optionally range from between three to 50. The number or first layers applied to the edible core 10 can optionally range from between ten to 20. The number of second layers 12 in the process of the invention, for example applied over respective first layers 11, can optionally range from between one to 100. The number of second layers 12 in the process of the invention, or example applied over respective first layers, can optionally range from between three to 50. The number of second layers in the process of the invention, for example applied over respective first layers, can optionally range from between ten to 20. The number of second layers 12 in the finished product can optionally be equal to, or the same as, the number of first layers 11 in the product. The number of first layers 11 and second layers 12 in the finished product can optionally be different in number.

### Flavor Enhancer

If the recipe of the given multilayered edible good requires a flavor enhancer coating layer; an optional flavor enhancer compound can be prepared, for example in block step 100, depending on or as a function of the type of final product required. The recipe of the specific ingredients of the flavor enhancer coating layer can include, without limitation for example, sugar, sucrose soy, an edible oil, seasoning, chili powder, colorants, salt, spices, other ingredients or any combination of the foregoing, for example in a dry component fashion. The flavor enhancer coating layer can be of any suitable thickness, for example from about 0.001 millimeters to 0.30 millimeters. The thickness of the flavor enhancer coating layer can optionally be less than the thickness of the first coating layer 11. The flavor enhancer coating layer can optionally be of a dusty nature.

The application of the flavor coating enhancer layer can be accomplished in any suitable manner such as a coating operation, for example in block step 110. Equipment suitable for performing a coating operation of the flavor enhancer layer can include, without limitation for example, a panning device, a conveyor, a tumbling drum, a centrifuge tub, a mixing vessel, a coating tube, a coating drum, a fluidized bed drier, other coating methods available in the art or any combination of the foregoing. The application of the flavor coating enhancer layer over the second cooked layer 12 can optionally take place at ambient temperature, or any other suitable temperature.

### Features and Advantages of the Final Product

The multilayered shell dough snack prepared according to the above method can present the following sensory features and attributes:

The edible core 10 can be completely cooked and therefore provide a pleasing taste. The multilayered shell dough snack can optionally present a crispy crunchy aspect at the center of the product provided by the first baked layer 11. A soft sensation upon biting the multilayered coated edible snack product can be provided due to optional expansion of the second cooked layer.

An optional expansion of the second coating layer 12 can be achieved with a lesser amount of supplies compared to the traditional process for the Dutch peanut type, wherein as is known by a person skilled in the art, only the first coating process and later frying exist.

Tests undertaken by applicant show that the multilayered coated edible snack product of the invention can present an expansion percentage of the fried second compound layer coating 12 which is higher than approximately 35%, typically between approximately 35% and 50%, as well as a porosity between both first and second coating layers (11, 12) from between approximately 60%-90%, such that the first coating layer 11 is found separated from the second coating layer 12, which grants a higher volume and bestows the sensation of a greater amount of product with few supplies, thereby allowing to decrease costs.

The surface of the second cooked layer can optionally not be uniform, which gives the second cooked layer a different appearance than that which exists in the state of the art, and can allow easy adherence of any subsequent liquid or powder or dusted flavor enhancer layer to the second layer.

The first cooked layer can optionally be cooked by frying. The second cooked layer can optionally be cooked by baking.

The figures attached to the present description illustrate the above described method applied to peanuts. Notwithstanding, the person skilled in the art will understand that these shall not be understood as a limitation of the invention.

Alterations of the invention described herein may be foreseen by those persons skilled in the art. The embodiments of the invention described and illustrated herein are merely for illustrative purposes, and are not a limitation of the scope of the invention. All the obvious amendments in the spirit of the invention, such as changes to the shape, material and sizes of the features which make up the invention, should be considered to lie within the scope of the attached claims.

Despite the state of the art proposing various solutions, no process exists which combines the sequence of steps disclosed in present invention, which result in products with the features described herein.

We claim:

1. A method of producing a multicoated edible snack product comprising the steps of:
providing an edible core having an outer surface and formed of a raw material;
applying a first layer over the outer surface of the edible core, the first layer formed of first cookable components that harden upon cooking;
cooking the first layer to form a hardened first layer over the edible core;
applying a second layer over the hardened first layer, the second layer formed of second cookable components that expand upon cooking; and
cooking the second layer to form an expanded second layer;
whereby the hardened first layer provides a crunchy aspect to the snack product and the expanded second layer provides a soft exterior to the snack product when biting into the snack product.

2. The method of claim 1, wherein the step of cooking the second layer includes cooking the second layer to form an expanded second layer that has partially separated from the hardened first layer.

3. The method of claim 2, wherein the step of cooking the second layer includes frying the second layer in an edible frying fluid to facilitate separation of the second layer from the hardened first layer.

4. The method of claim 3, wherein the edible frying fluid is a cooking oil.

5. The method of claim 1, wherein the step of cooking the second layer includes frying the second layer in a cooking oil to create air bubbles between the expanded second layer and the hardened first layer.

6. The method of claim 1, wherein the step of cooking the first layer includes baking the first layer and the step of cooking the second layer includes frying the second layer.

7. The method of claim 1, wherein the second cookable components have a higher starch to flour ratio than the first cookable components to facilitate expansion of the second layer upon cooking.

8. The method of claim 7, wherein the second cookable components have a content of starch ranging from approximately 30% to 60% in weight and a content of flour ranging from approximately 10% to 40% in weight.

9. The method of claim 1, wherein the first cookable components have a content of starch ranging from approximately 10% to 30% in weight and content of flour ranging from approximately 40% to 70% in weight.

10. The method of claim 1, wherein the edible core is selected from the group consisting of nuts, almonds, peanuts, nut derivatives, seeds, legumes, garbanzo beans, lima beans, whole grains, corn, seeds, fruits, dried fruits, fruits derivatives, dried vegetables and any combination or mixture of the foregoing.

11. The method of claim 1, wherein the step of cooking the first layer includes sealing the edible core.

12. The method of claim 1, further comprising applying a binder layer over the edible core before the step of applying the first layer to enhance adherence of the hardened first layer to the edible core.

13. The method of claim 1, further comprising applying a flavor enhancer over the expanded second layer.

14. The method of claim 1, wherein the hardened first layer has a thickness and the expanded second layer has a thickness greater than the thickness of the hardened first layer.

15. A method of producing a multicoated edible snack product comprising the steps of:
providing an edible core having an outer surface and formed of a raw material;
applying a first layer over the outer surface of the edible core, the first layer formed of first cookable components that harden upon cooking;
cooking the first layer to form a hardened first layer over the edible core;
applying a second layer over the hardened first layer, the second layer formed of second cookable components that expand upon cooking; and
frying the second layer in an edible frying fluid to form an expanded second layer and to create air bubbles between the expanded second layer and the hardened first layer;
whereby the hardened first layer provides a crunchy aspect to the snack product and the expanded second layer provides a soft exterior to the snack product when biting into the snack product.

16. The method of claim 15, wherein the edible frying fluid is a cooking oil.

17. The method of claim 15, wherein the second cookable components have a higher starch to flour ratio than the first cookable components to facilitate expansion of the second layer upon cooking.
